(19) United States
(12) Patent Application Publication
(10) Pub. No.: US 2023/0086113 A1
(43) Pub. Date: Mar. 23, 2023

(54) CROWD-SOURCED AUTOMATION OF AUTHENTICATION

(71) Applicant: EVRYTHNG Ltd, Beaverton, OR (US)

(72) Inventors: Dominique Guinard, Troistorrents (CH); Shmuel Silverman, Novato, CA (US)

(21) Appl. No.: 17/894,823

(22) Filed: Aug. 24, 2022

Related U.S. Application Data
(60) Provisional application No. 63/236,683, filed on Aug. 24, 2021.

(51) Int. Cl. H04W 12/71; H04W 12/61; H04W 12/63

(52) U.S. Cl. CPC H04W 12/71; H04W 12/61; H04W 12/63

(57) ABSTRACT

A computer system that provides feedback information is described. During operation, the computer system may receive, associated with the electronic device, information associated with a portion of an image of a product, where the information specifies an identifier of the product and a location where the image was acquired.

For example, the identifier may include a universal unique identifier or may specify a second location in the network. Then, the computer system may determine whether the identifier is authentic. Notably, the authenticity may be determined based at least in part on a geographic constraint on the product and the location. Next, when the identifier is authentic, the computer system may provide, addressed to a second computer, the feedback information about the product, where the second computer is associated with or is included in a supply chain of the product.

### CROSS REFERENCE TO RELATED APPLICATIONS

This application claims priority under 35 U.S.C. 119(e) to U.S. Provisional Application Ser. No. 63/236,683, entitled “Crowd-Sourced Automation of Authentication,” by Dominique Guinard, et al., filed on Aug. 24, 2021, the contents of which are herein incorporated by reference.

### FIELD

The described embodiments relate generally to techniques for authenticating a product or a service. Notably, the described embodiments relate to techniques for authenticating products using distributed information acquired by multiple individuals.

### BACKGROUND

It is often easy to duplicate the original information printed or marked on a box or package for a product (which is sometimes referred to as ‘goods’). Then, by including new or fake content in the duplicated box, a fraudulent or counterfeit product can be sold as if it is an authentic product. This is frustrating to manufacturers, fulfillment personnel, supply-chain staff and receivers or customers.

A variety of authentication solutions attempt to provide visibility to supply-chain integrity issues, such as gray markets, backdoor goods or counterfeits. For example, many authentication solutions are based on tags that are hard to copy and/or on brand inspectors that purchase and analyze items in stores.

However, the ‘hard to copy’ tags may sometimes be copied or ignored by using alternative tags. Moreover, material-science technologies that are often used to make tags hard to copy are relatively expensive, which makes these authentication solutions impractical for many applications. Furthermore, authentication solutions that are based on brand inspectors are often hard to scale as business and distribution channels and locations scale or change over time.

### SUMMARY

In a first group of embodiments, a computer system that provides feedback information is described. This computer system may include: a network interface that communicates with an electronic device and a second computer; a processor; and memory that stores program instructions, where, when executed by the processor, the program instructions cause the computer system to perform operations. During operation, the computer system receives, associated with the electronic device, information associated with a portion of an image of a product, where the information specifies an identifier of the product and a location where the image was acquired. Then, the computer system determines whether the identifier is authentic. Next, when the identifier is authentic, the computer system provides, addressed to the second computer, the feedback information about the product, where the second computer is associated with or is included in a supply chain of the product.

Note that the identifier may include a universal unique identifier. For example, the universal unique identifier may include an identifier that is compatible with a GS1 Digital Link standard.

Moreover, the identifier may specify a second location in a network. For example, the second location may include a uniform resource locator (URL) and/or a uniform resource identifier (URI).

Furthermore, the feedback information may include the location and a timestamp when the image was acquired. Additionally, the feedback information may include a context about use of the product.

In some embodiments, the authenticity may be determined based at least in part on a geographic constraint on the product and the location. Moreover, the authenticity may be determined based at least in part on second information specifying the identifier and a third location where a second portion of a second image of the product was acquired. Note that the third location may be different from the location and a timestamp when the image was acquired may be within a time interval (such as an hour) of a second timestamp when the second image was acquired.

Furthermore, the portion of the image may be extracted by an application installed on and executed by the electronic device. Note that the image may include a photograph of the product and/or a scan of the identifier.

Another embodiment provides the electronic device, which may perform counterpart operations to at least some of the aforementioned operations.

Another embodiment provides a computer-readable storage medium for use with the computer system or the electronic device. When executed by the computer system or the electronic device, this computer-readable storage medium causes the computer system or the electronic device to perform at least some of the aforementioned operations.

Another embodiment provides a method that may be performed by the computer system or the electronic device. This method includes at least some of the aforementioned operations.

In a second group of embodiments, a computer system that provides or facilitates globally unique code (such as GS1 Digital Link)-based crowdsourcing and/or supply-chain management is described. The globally unique code may specify or may include a location in a network (such as a URI or a URL), such that the globally unique code enforces multi-factor authentication. Moreover, the globally unique code may be used consistently with a product throughout: manufacturing, distribution, store display, brand inspection and/or consumer crowdsourcing.

Furthermore, the globally unique code may be used by a consumer and information associated with the consumer may be provided to the supply chain. Additionally, the globally unique code may be a second authentication factor, such that a forger may need to provide a new code that is not used by anyone and a URI with information that duplicates the globally unique code. In some embodiments, the computer system performs analysis techniques to identify, trace and provide assessment of product links (e.g., GS1 Digital Links) and potential duplications.

Another embodiment provides an electronic device associated with the consumer, which may perform counterpart operations to at least some of the aforementioned operations.

Another embodiment provides a computer-readable storage medium for use with the computer system or the electronic device. When executed by the computer system or the electronic device, this computer-readable storage medium causes the computer system or the electronic device to perform at least some of the aforementioned operations.

Another embodiment provides a method that may be performed by the computer system or the electronic device. This method includes at least some of the aforementioned operations.

In a third group of embodiments, a computer system that provides or facilitates image-based crowdsourcing and/or supply-chain management is described.

The images, which may be taken during a manufacturing process, may be biased towards or weighted towards the images or perspectives that may be taken by the consumer (which may help ensure a product can be identified using a manufacture image and a consumer image). Moreover, one or more consumers may crowdsource consumer images of products and the computer system may use perform a correlation/comparison to a product data structure or database (with product information, such as: images or products, dates, times and/or confidence levels) for identification, authentication, and brand inspection. Furthermore, these authentication techniques may increase supply-chain transparency using the images (such as three-dimensional or 3D images) taken during the manufacturing process and correlating/comparing this image to the consumer (crowdsourced imaging) of a product. Additionally, the computer system may generate a 3D image of a product using multiple images associated with various angles or perspectives. Note that the images taken during the manufacturing process may be used to identify blemishes associated with a specific line of products, which may be subsequently used to authenticate a product. In some embodiments, the computer system may use predefined or pretrained machine learning and neural networks for image classification.

Moreover, the computer system may perform product color mapping with or without the use of analysis techniques or training a predictive mode (e.g., using machine learning, such as a neural network). Furthermore, the computer system may be capable of identifying conclusive versus inconclusive results when identifying a product. Note that the correlation data structure or database may be sorted using a hash key that is a mathematical function of a circumference of an image.

Another embodiment provides an electronic device associated with the consumer, which may perform counterpart operations to at least some of the aforementioned operations.

Another embodiment provides a computer-readable storage medium for use with the computer system or the electronic device. When executed by the computer system or the electronic device, this computer-readable storage medium causes the computer system or the electronic device to perform at least some of the aforementioned operations.

Another embodiment provides a method that may be performed by the computer system or the electronic device. This method includes at least some of the aforementioned operations.

In a fourth group of embodiments, a computer system that provides or facilitates gamification of authentication by a crowd (or multiple individuals) is described. For example, the computer system may provide a crowdsourcing game system that allows consumers to collect points/feedback when they share what they see with the computer system. The computer system may include: a network interface that communicates with electronic devices (such as an augmented reality device, a virtual reality device, a smartphone, a camera, one or more sensors, etc.). A consumer or an individual may select a product (such as a product having a certain type/brand in a given store) and scan it using video feed (or multiple images) acquired from multiple angles or perspectives. Notably, an application executing on an electronic device of the consumer may scan or acquire multiple video feeds. Depending on the available communication bandwidth, the consumer may share such information in a sampled or a continuous manner. Moreover, the computer system may provide points (or rewards) to an account of the consumer when the application is active and/or when the consumer finds products of a particular type/brand in different stores, such as rare product-store combinations. Furthermore, the consumer may identify or spot products that they do not think should be at a particular location and/or that they think or counterfeit, and may indicate why they think this to the computer system. Alternatively or additionally, a consumer may use their electronic device to provide a scan of a market or a store for analysis by the computer system. In some embodiments, the computer system (and/or the application) may provide an avatar that plays along with a consumer (e.g., in augmented reality) and helps them to select products to inspect as part of a game. Note that point may be collected by the consumers and may be viewed via the application.

Another embodiment provides the electronic device, which may perform counterpart operations to at least some of the aforementioned operations.

Another embodiment provides a computer-readable storage medium for use with the computer system or the electronic device. When executed by the computer system or the electronic device, this computer-readable storage medium causes the computer system or the electronic device to perform at least some of the aforementioned operations.

Another embodiment provides a method that may be performed by the computer system or the electronic device. This method includes at least some of the aforementioned operations.

In a fifth group of embodiments, a computer system that provides or facilitates user privacy via blockchain wallets. The computer system may eliminate a need for identification of a user in order to provide payment to crowdsource game player. Notably, when the user dynamically chooses to participate in the game, the computer system may receive a wallet public key from an electronic device of or associated with the user. Then, the computer system may receive user authorizes for the use of their streaming video feed or imaging of products at different locations and/or in different environments. Note that a given universal code or other input received from an electronic device of the user may cause the computer system to generate or provide in a micro deposit into the user wallet.

Another embodiment provides the electronic device, which may perform counterpart operations to at least some of the aforementioned operations.

Another embodiment provides a computer-readable storage medium for use with the computer system or the electronic device. When executed by the computer system or the electronic device, this computer-readable storage medium causes the computer system or the electronic device to perform at least some of the aforementioned operations.

Another embodiment provides a method that may be performed by the computer system or the electronic device. This method includes at least some of the aforementioned operations.

In a sixth embodiment, a computer system that provides or facilitates edge analysis and mapping is described. The computer system may use a pretrained predictive model, which was trained using a machine-learning technique, to identify a universal product code. Notably, the computer system may perform operations including: based at least in part on a user location, accessing or downloading possible products images and types and the pretrained predictive model (such as a neural network) to track in this location; and/or as the user provides one or more video streams, the computer system (and/or an application executing on an electronic device associated with the user) analyzes the one or more video streams looking for a predefined set of products, e.g., by piggybacking on in-view information received from a third-party cloud application. Moreover, a given product marked by the third-party application and that is not in the predefined set of products may be chosen by the computer system and/or the user for subsequently exploration/review. Note that the user may perform counterpart operations as part of a crowdsourced game.

Another embodiment provides the electronic device, which may perform counterpart operations to at least some of the aforementioned operations.

Another embodiment provides a computer-readable storage medium for use with the computer system or the electronic device. When executed by the computer system or the electronic device, this computer-readable storage medium causes the computer system or the electronic device to perform at least some of the aforementioned operations.

Another embodiment provides a method that may be performed by the computer system or the electronic device. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for providing feedback using a computer system of FIG. 1 in accordance with an embodiment of the present disclosure.

FIG. 3 is a drawing illustrating an example of communication among electronic devices in FIG. 1 in accordance with an embodiment of the present disclosure.

FIG. 4 is a drawing illustrating a manufacturing and supply-chain flow in accordance with an embodiment of the present disclosure.

FIG. 5 is a drawing illustrating a duplicate-flow-detection analysis technique in accordance with an embodiment of the present disclosure.

FIG. 6 is a drawing illustrating a supply-chain feedback loop in accordance with an embodiment of the present disclosure.

FIG. 7 is a drawing illustrating an image-based crowdsourcing technique in accordance with an embodiment of the present disclosure.

FIG. 8 is a drawing illustrating a three-dimensional (3D) imaging technique during manufacturing in accordance with an embodiment of the present disclosure.

FIG. 9 is a drawing illustrating potential perspectives of a product in accordance with an embodiment of the present disclosure.

FIG. 10 is a drawing illustrating a 3D ball with surface sectors in accordance with an embodiment of the present disclosure.

FIG. 11 is a drawing illustrating a comparison technique in accordance with an embodiment of the present disclosure.

FIG. 12 is a drawing illustrating a correlation and matching flow in accordance with an embodiment of the present disclosure.

FIG. 13 is a drawing illustrating a privacy-based crowdsourcing flow in accordance with an embodiment of the present disclosure.

FIG. 14 is a drawing illustrating a product-identification flow in accordance with an embodiment of the present disclosure.

FIG. 15 is a drawing illustrating edge-based analysis and mapping in accordance with an embodiment of the present disclosure.

FIG. 16 is a drawing illustrating removal of duplicate scans and product authentication in accordance with an embodiment of the present disclosure.

FIG. 17 is a drawing illustrating a product identification technique in accordance with an embodiment of the present disclosure.

FIG. 18 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system (which may include one or more computers) that provides feedback information is described. During operation, the computer system may receive, associated with the electronic device, information associated with a portion of an image of a product, where the information specifies an identifier of the product and a location where the image was acquired. For example, the identifier may include a universal unique identifier or may specify a second location in the network (such as a uniform resource locator or URL and/or a uniform resource identifier or URI). Then, the computer system may determine whether the identifier is authentic. Notably, the authenticity may be determined based at least in part on a geographic constraint on the product and the location. Next, when the identifier is authentic, the computer system may provide, addressed to a second computer, the feedback information about the product (such as a context about use of the product), where the second computer is associated with or is included in a supply chain of the product.

By providing the feedback, these authentication techniques may allow crowdsourced information (such as the portion of the image) to be used in authentication. Moreover, the authentication techniques may allow the contexts associated with products to be collected and assessed. These capabilities may provide visibility to supply-chain integrity issues, such as gray markets, backdoor goods or counterfeits. Furthermore, by reducing or eliminating counterfeit or fraudulent products and/or unauthorized distribution of the products, the authentication techniques may facilitate insurance instruments for products. Consequently, the authentication techniques may increase the trustworthiness of products and the reliability of a variety of marketplaces (such as physical and/or online marketplaces) without requiring the use of expensive tags or brand inspection, which may not scale well. Therefore, the authentication techniques may simplify supply-chain management (e.g., by reducing confusion, errors and/or malicious actions, as well as the associated expenses), may be easier to use for manufacturers, fulfillment personnel, supply-chain staff and receivers or customers, and thus may result in increased commercial activity.

In some embodiments, at least a portion of the authentication techniques may be implemented in a distributed or decentralized manner. Alternatively, in some embodiments, at least a portion of the authentication techniques may be implemented in a centralized manner.

In the discussion that follows, electronic devices may communicate packets or frames with wired and/or wireless networks (e.g., via access points, radio nodes and/or base stations) in accordance with a wired communication protocol (such as an Institute of Electrical and Electronics Engineers or IEEE 802.3 standard, which is sometimes referred to as ‘Ethernet’, or another type of wired interface) and/or a wireless communication protocol, such as: an IEEE 802.11 standard (which is sometimes referred to as ‘Wi-Fi,’ from the Wi-Fi Alliance of Austin, Tex.), Bluetooth (from the Bluetooth Special Interest Group of Kirkland, Wash., a cellular-telephone communication protocol (such as 2G, 3G, 4G, 5G, Long Term Evolution or LTE, another cellular-telephone communication protocol, etc.) and/or another type of wireless interface. In the discussion that follows, Wi-Fi, a cellular-telephone communication protocol and Ethernet are used as an illustrative example. However, a wide variety of communication protocols may be used. Note that the wireless communication may occur in a variety of frequency bands, such as: a cellular-telephone communication band, a frequency band associated with a Citizens Band Radio Service, a Wi-Fi frequency band (such as a 2.4 GHz, a 5 GHz, a 6 GHz and/or a 60 GHz frequency band), etc.

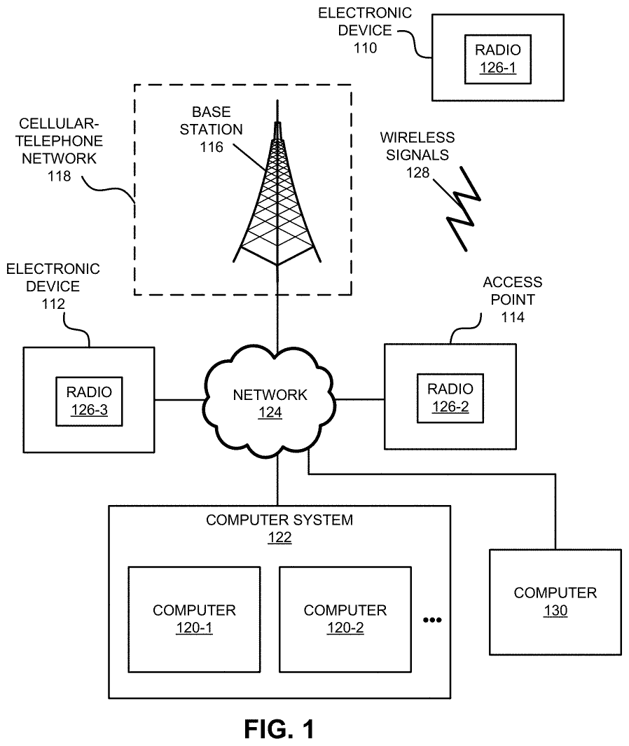

FIG. 1 presents a block diagram illustrating an example of communication among one or more of electronic devices 110 and 112 (such as a cellular telephone, a computer, etc., and which are sometimes referred to as ‘clients’), access point 114, base station 116 in cellular-telephone network 118, and one or more computers 120 in computer system 122 in accordance with some embodiments. Access point 114 and base station 116 may communicate with computer system 122 via network 124 (such as the Internet) using wireless and/or wired communication (such as by using Ethernet or a communication protocol that is compatible with Ethernet), and may communicate with electronic device 110 using wireless communication (Wi-Fi and a cellular-telephone communication protocol, respectively). Note that access point 114 may include a physical access point and/or a virtual access point that is implemented in software in an environment of an electronic device or a computer. In addition, access point 114 and/or base station 116 may communicate with electronic devices 110 using wireless communication, while electronic device 112 may communicate with computer system 122 via network 124.

While not shown in FIG. 1, the wired and/or wireless communication with electronic devices 110 and/or 112 may further occur via an intranet, a mesh network, point-to-point connections, etc., and may involve one or more routers and/or switches. Furthermore, the wireless communication may involve: transmitting advertising frames on wireless channels, detecting one another by scanning wireless channels, establishing connections (for example, by transmitting association or attach requests), and/or transmitting and receiving packets or frames (which may include the association requests and/or additional information as payloads). In some embodiments, the wired and/or wireless communication in FIG. 1 also involves the use of dedicated connections, such as via a peer-to-peer (P2P) communication technique.

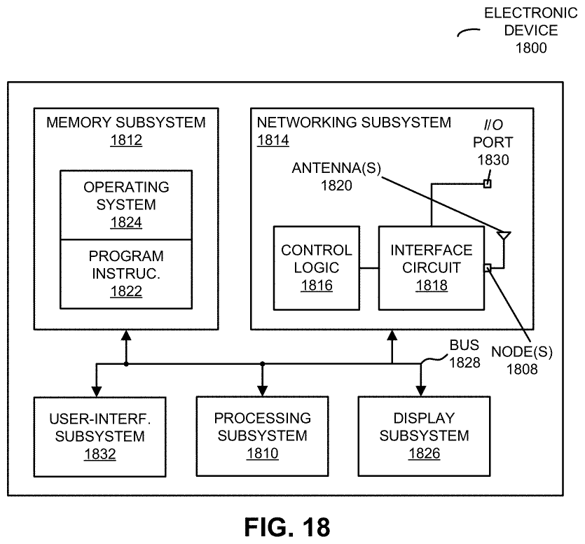

As described further below with reference to FIG. 18, electronic device 110, electronic device 112, access point 114, base station 116, and/or computers 120 may include subsystems, such as a networking subsystem, a memory subsystem and a processor subsystem. In addition, electronic device 110, access point 114 and base station 116 may include radios 126 in the networking subsystems. More generally, electronic device 110, electronic device 112 and access point 114 can include (or can be included within) any electronic devices with the networking subsystems that enable electronic device 110 and access point 114 to communicate with each other using wireless and/or wired communication. This wireless communication can comprise transmitting advertisements on wireless channels to enable access point 114 and/or electronic device 110 to make initial contact or detect each other, followed by exchanging subsequent data/management frames (such as association requests and responses) to establish a connection, configure security options (e.g., Internet Protocol Security), transmit and receive packets or frames via the connection, etc. Note that while instances of radios 126 are shown in electronic device 110 and access point 114, one or more of these instances may be different from the other instances of radios 126.

As can be seen in FIG. 1, wireless signals 128 (represented by a jagged line) are transmitted from radio 126-1 in electronic device 110. These wireless signals may be received by radio 126-2 in access point 114. Notably, electronic device 110 may transmit packets or frames. In turn, these packets or frames may be received by access point 114. Moreover, access point 114 may allow electronic device 110 to communicate with other electronic devices, computers and/or servers via network 124.

Note that the communication among components in FIG. 1 may be characterized by a variety of performance metrics, such as: a received signal strength (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

In the described embodiments processing a packet or frame in electronic device 110 and/or access point 114 includes: receiving signals (such as wireless signals 128) with the packet or frame; decoding/extracting the packet or frame from received wireless signals 128 to acquire the packet or frame; and processing the packet or frame to determine information contained in the packet or frame.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

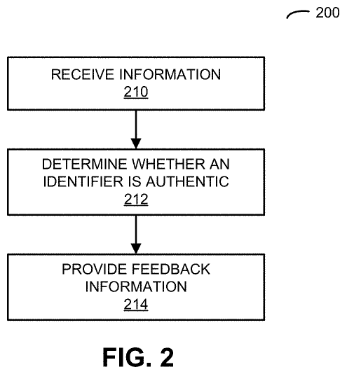

As discussed previously, it is often difficult to authenticate products in a simple and efficient manner. In order to address these problems, as described further below with reference to FIGS. 2-17, the authentication techniques may be used to provide different embodiments. For example, the authentication techniques may leverage crowdsourced information to authenticate products and/or to collect and analyze contexts associated with the products. Notably, an electronic device (such as electronic device 110 or 112) may provide to computer system 122 (such as computer 120-1) one or more images (which are sometimes referred to as ‘photographs,’ ‘scans’ or ‘video feeds’) of an object (such as a product) or a label associated with the product (such as an image of the label). In the discussion that follows, electronic device 110 is used to illustrate the authentication techniques.

Electronic device 110 may obtain an identifier of the product by scanning or acquiring an image of the identifier or the label that includes the identifier. For example, an application installed on and executed by electronic device 110 may acquire and/or extract at least a portion of the one or more images that includes the identifier.

In some embodiments, electronic device 110 may obtain the identifier by performing an image-processing or an image-analysis technique on the label or an image of the label. This image-processing or image-analysis technique may include: an edge or a line-segment detector, a texture-based feature detector, a texture-less feature detector, a scale invariant feature transform (SIFT)-like object-detector, a speed-up robust-features (SURF) detector, a binary-descriptor (such as ORB) detector, a binary robust invariant scalable keypoints (BRISK) detector, a fast retinal keypoint (FREAK) detector, a binary robust independent elementary features (BRIEF) detector, a features from accelerated segment test (FAST) detector, and/or another image-processing or image-analysis technique. Alternatively or additionally, in some embodiments the image may be analyzed using a pre-trained machine-learning model. Note that the pre-trained machine-learning model may have been trained using a machine-learning technique, such as a supervised-learning technique. The supervised-learning technique may include: a classification and regression tree, a support vector machine (SVM), linear regression, nonlinear regression, logistic regression, least absolute shrinkage and selection operator (LASSO), ridge regression, a random forest, and/or another type of supervised-learning technique. In some embodiments, the pre-trained machine-learning model may include a pre-trained neural network, such as a convolutional neural network or a recurrent neural network.

Furthermore, the identifier may include a universal unique identifier or a globally unique identifier or code. For example, the identifier may include or may be compatible with: a global standards 1 (GS1) Digital Link, a global trade item number (GTIN), a serial shipping container (SSCC), a serialized global trade item number (SGTIN), an European article number code (EAN), a universal product codes (UPC), an electronic product code (EPC), a global location number (GLN), an international standard book identifier (ISBN), a global returnable asset identifier (GRAI), a global coupon number (GCN), an Amazon standard identification number (ASIN), a global shipment identification number (GSIN), a universally unique identifier (UUID), a global document type identifier (GDTY), a globally unique identifier (GUID), an Eddystone UID or EID, an international mobile equipment identity (IMEI), an eSIM identifier, a pharmaceutical product identifier (PhPID), a serial number, a blockchain address, a blockchain transaction identifier, a hash or hash table, a blockchain token, an ERC721 token, a non-fungible token, and/or a public key. In some embodiments, the identifier may be a random or a pseudo-random number.

Computer 120-1 may receive the one or more images, a portion of an image of a product or information corresponding to at least the portion of the image. This portion of the image may include the identifier of the product and a location where the image was acquired.

Then, computer 120-1 may determine whether the identifier is authentic. For example, computer 120-1 may access (e.g., in local memory and/or remotely located memory associated with computer system 122) information associated with a data structure for products. This data structure may include, for a given product, authentication information, such as: one or more images of the product (such as images acquired during manufacturing of the product, images acquired by users or consumers, a 3D image of the product, etc.), allowed locations of the product, timestamps associated with the images, and/or a pretrained predictive model that can be used to authenticate the product.

Note that the data structure may have been previously provided to computer system 122 (e.g., by a manufacturer of the given product) and/or may have been acquired by computer system 122 when the product was manufactured, at different locations in the supply or fulfillment chains (such as in warehouse, transportation hubs, vehicles, supply-chain fulfillment centers and/or retail establishments), and/or by users or consumers (e.g., via a crowdsourced game). Moreover, note that the identifier may be used consistently with the product throughout: manufacturing, distribution, store display, brand inspection and/or consumer crowdsourcing.

For example, computer 120-1 may provide information such as or corresponding to the identifier, at least the portion of the image and/or the location as inputs to the pretrained predictive model, and the pretrained predictive model may output an authentication score for the product. When the authentication score exceeds a threshold (such as 0.5), computer 120-1 may confirm that the product is authentic.

In some embodiments, the identifier may specify or may include a second location in a network (such as a URI or a URL). Computer 120-1 may access this second location in order to perform multi-factor authentication of the product. For example, the identifier and the location may provide authentication factors. In these embodiments, a forger may need to provide a new identifier that is not used by or in conjunction with another product and that duplicates the identifier in order to authenticate the product.

Alternatively or additionally, computer 120-1 may determine the authenticity based at least in part on a geographic constraint on the product and the location. For example, the product may be deemed authentic when the location matches a predefined or allowed location in the data structure. Alternatively or additionally, the product may be deemed authentic when the location matches locations of other images of the product or instances of the product (which were acquired by the same or different consumer(s) previously).

Moreover, computer 120-1 may determine the authenticity based at least in part on second information specifying the identifier and a third location where a second portion of a second image of the product was acquired. For example, computer 120-1 may compare the information associated with the image with the second information associated with the second image, which may have been previously acquired by the same or another user or consumer, and which may be stored in the data structure. Note that the third location may be different from the location and a timestamp when the image was acquired may be within a time interval (such as an hour) of a second timestamp when the second image was acquired.

Next, when the identifier is authentic, computer 120-1 may provide, addressed to computer 130 (which may be associated with or is included in a supply chain of the product), the feedback information about the product. This feedback information may indicate or specify whether the product is authentic based at least in part on the authentication score. Moreover, the feedback information may include the location and a timestamp when the image was acquired. Additionally, the feedback information may include a context about use of the product, such as where the product is sold or used (e.g., the environments or retail establishments or stores). In some embodiments, the feedback information includes information associated with the consumer.

After receiving the feedback information, computer 130 may aggregate the feedback information (e.g., in a data structure or a database), which may be stored in local memory and/or remotely located memory associated with computer 130. In some embodiments, computer 130 performs remedial action, such as when the feedback information indicates the identifier and, thus, the product is not authentic. For example, computer 130 may: alert law enforcement, a retail establishment where the product is on-sale, perform analysis to determine whether the product is a backdoor good, etc. Moreover, computer 130 may analyze the feedback information to: identify, trace and/or provide assessment of product links or relationships, or to asses potential duplication or fraudulent activity.

In these ways, computer system 122 may provide end-to-end authentication of the product in an online or a physical supply or fulfillment chain, or in a marketplace. Thus, the authentication techniques may help ensure or guarantee the authenticity of a product. Consequently, the authentication techniques may reduce or eliminate fraud and, thus, may reduce the associated costs. Therefore, the authentication techniques may enhance trust in the instances of the product, and in marketplaces that sell or conduct commercial transactions that include or involve the product.

While the preceding embodiments illustrated the authentication techniques being implemented via a cloud-based computer system 122, in other embodiments at least some of the aforementioned operations may be performed locally on, e.g., electronic device 110 or 112. Thus, operations in the authentication techniques may be performed locally or remotely.

We now describe embodiments of a method. FIG. 2 presents a flow diagram illustrating an example of a method 200 for providing feedback information using a computer system, such as one or more computers 120 in computer system 122 (FIG. 1). During operation, the computer system may receive, associated with an electronic device, information (operation 210) associated with a portion of an image of a product, where the information specifies an identifier of the product and a location where the image was acquired. Note that the identifier may include a universal unique identifier. For example, the universal unique identifier may include an identifier that is compatible with a GS1 Digital Link standard. Moreover, the identifier may specify a second location in a network. Notably, the second location may include a URL and/or a URI. Furthermore, the portion of the image may be extracted by an application installed on and executed by the electronic device. Note that the image may include a photograph of the product and/or a scan of the identifier.

Then, the computer system may determine whether the identifier is authentic (operation 212). In some embodiments, the authenticity may be determined based at least in part on a geographic constraint on the product and the location. Moreover, the authenticity may be determined based at least in part on second information specifying the identifier and a third location where a second portion of a second image of the product was acquired. Note that the third location may be different from the location and a timestamp when the image was acquired may be within a time interval (such as an hour) of a second timestamp when the second image was acquired.

Next, when the identifier is authentic, the computer system may provide, addressed to a second computer, the feedback information (operation 214) about the product, where the second computer is associated with or is included in a supply chain of the product. Furthermore, the feedback information may include the location and a timestamp when the image was acquired. Additionally, the feedback information may include a context about use of the product.

In some embodiments of method 200, there may be additional or fewer operations. Furthermore, the order of the operations may be changed, there may be different operations and/or two or more operations may be combined into a single operation.

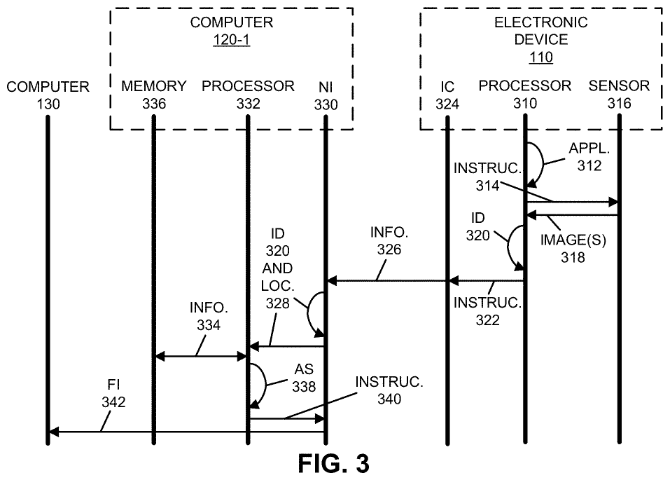

FIG. 3 presents a drawing illustrating an example of communication among electronic device 110 and computer 120-1. During the authentication techniques, a processor 310 in electronic device 110 may execute an application 312. This application may instruct 314 an image sensor 316 in electronic device 110 to acquire one or more images 318 of a product. Then, application 312 may extract an identifier (ID) 320 associated with a portion of at least one of the one or more images 318 of the product, such as an identifier associated with the product. Next, application 312 may instruct 322 an interface circuit (IC) 324 in electronic device 110 to provide information 326 to computer 120-1. This information may specify identifier 320 of the product and a location 328 where the at least one of the one or more images 318 was acquired (such as information from a local positioning system, information from a Global Positioning System or GPS, a media access control or MAC address, an Internet Protocol or IP address, etc.).

Next, a network interface (NI) 330 of computer 120-1 may receive information 326. Then, network interface 330 may extract identifier 320 and location 328 from information 326, and may provide identifier 320 and location 328 to a processor 332 in computer 120-1. In response, processor 332 may access information 334 (such as allowed locations of the product, one or more images of the product that were acquired previously, etc.), in memory 336 in computer 120-1, which is associated with a data structure for products. This data structure may include, for a given product, authentication information.

Moreover, processor 332 may determine whether identifier 320 (and, thus, the product) is authentic based at least in part on identifier 320, location 328 and information 334. For example, processor 332 may determine an authentication score (AS) 338 of the product based at least in part on the authentication information in information 336 for the product. In some embodiments, processor 332 may determine authentication 338 score using a pretrained predictive model, such as a pretrained neural network. Alternatively or additionally, determining authentication score 338 may include comparing one or more images 318 to previously acquired images, determining whether location 328 is an allowed location of the product, etc.

Furthermore, processor 332 may provide an instruction 340 to network interface 330 to provide, addressed to computer 130, feedback information (FI) 342. For example, feedback information 342 may indicate whether identifier 320 and/or the product is authentic based at least in part on authentication score 338. Additionally, when the identifier and/or the product is authentic, feedback information 342 may include location and a timestamp when the at least one of the one or more images 318 was acquired. Additionally, feedback information 342 may include a context about or circumstances associated with the use of the product.

While FIG. 3 illustrates communication between components using unidirectional or bidirectional communication with lines having single arrows or double arrows, in general the communication in a given operation in these figures may involve unidirectional or bidirectional communication.

We now further describe the authentication techniques. As noted previously, many solutions that attempt to provide visibility for supply-chain integrity issues (such as gray markets, backdoor goods or counterfeits) focus on delivering the visibility using tags that are hard to copy and/or by using brand inspectors that purchase and analyze items in stores. The disclosed authentication techniques take a different approach by focusing on the data traces products generate while being tracked in the supply chain (which is sometimes referred to as ‘data driven product authenticity’). Moreover, the disclosed authentication techniques may extend the reach of digital identities for products to consumers and to use the consumer's interactions with the products as data points to help solve integrity issues. For example, the location of consumer scans may be used to determine if a product is in its intended location (gray market) or the frequency of consumers' scans may be used to identify product identities that were potentially copied.

In the disclosed authentication techniques, during manufacturing, machine learning may be used to direct product scans that approximate ‘in the field’ or crowd-based. This data may be used to determine the authenticity of the product when it is subsequently scanned by one or more individuals using electronic device(s). In this context, the disclosed authentication techniques may be used to obtain a more-realistic replacement of a professional human-field inspector, who may have taken or acquired multiple images of the product in the field and sent them back to the office for analysis.

Moreover, in the disclosed authentication techniques, supply-chain identifiers may be used as digital triggers for consumers. Usually supply chain identifiers are not used by consumers (typically, these identifiers are only used by machines in the supply chain). In the disclosed authentication techniques, this information is used between the supply chain and the consumers. In this way, consumer input may be used as an input to supply-chain data.

Furthermore, in the disclosed authentication techniques, consumer interaction may become an operation in the supply chain. Additionally, one identifier or code may be used for two purposes; and/or consumer scans may be collected and may be used to detect fraud based at least in part on predefined rules and/or pretrained predictive models. In some embodiments, consumer interaction may be used as a distributed/crowd sourced-brand inspector. Notably, questions may be asked of the crowd. For example, authentication by the crowd may be gamified (which may only make sense at a crowd level).

Thus, consumers may feed or provide supply-chain integrity data. For example, consumers may acquire GS1 Digital Link or universal code information for a product. Notably, this information and/or associated images may be acquired during manufacturing, the supply chain and while being scanned or imaged in the field by the crowd. Using this information, the context of the scan and/or a portion of an image, product authenticity may be assessed. Moreover, the results may be feedback to the supply chain, thereby providing information about products in context based at least in part on the crowdsourcing. More generally, regardless of the presence of an identifier, image assessment may be used to provide higher integrity and in order to reduce friction with the crowdsourcing. In some embodiments, the crowdsourcing may be gamified. For example, there may be multiple type of games with increased rewards based at least in part on user activity. Furthermore, blockchain wallets may be used as a way to track incentives for individuals while maintaining privacy. Additionally, edge analysis/mapping of inputs to products (e.g., based at least in part on augmented or virtual reality) may be used depending on the availability of sufficient broadband communication. Note that the mapping may be of identifiers and the contexts for the crowdsourcing brand inspection system.

Consequently, in the disclosed authentication techniques, multi-factor GS1 Digital Link-based tagging, which can be verified by crowdsourced activity, may be used to authenticate products. In these authentication techniques consumers may be used as brand inspectors. The collected data may be used across the entire supply chain to improve-supply chain management and/or to provide timely supply-chain feedback from crowdsourced field inputs. Moreover, the crowdsource activity may be gamified or turned into a game to encourage and enable individual participation in the crowdsource activity. Furthermore, privacy issues that are often associated with crowdsource-based information collection and exchange in public and private spaces may be addressed, so that users' identities are protected using a no-data solution. Additionally, high-speed uplink data feed and real-time image-analysis network bottlenecks may be addressed by collecting crowdsourcing input data, so that the authentication techniques have high performance and prompt results. Note that the disclosed authentication techniques may provide a cloud-based computer system or a full end-to-end system (such as the cloud-based computer system and an application that can be installed on and executed in environments on user's electronic devices) to enable crowdsourcing-based supply-chain management.

### Identifier-Based Crowdsourcing and Supply-Chain Management.

In the discussion that follows, GS1 Digital Links are used as an illustrative example of the identifier (which is sometimes referred to as a ‘code’). GS1 Digital Links may be used to help barcodes and other data carriers become Internet links, thereby connecting a unique identity of a product to online sources of real-time information that brands control.

The GS1 Digital Link standard extends the power and flexibility of GS1 identifiers by making them part of the Internet. This means that GS1 identifiers (such as a GTIN) may be used as a gateway to consumer information to strengthen brand loyalty, improve supply-chain traceability information, improve business partner application programming interfaces (APIs), etc.

GS1 Digital Links are often assigned to and printed on a product (e.g., on a sticker that may be attached to or directly printed on the product). The product may be identified using this GS1 code. In the disclosed authentication techniques, a serialized GS1 Digital Link may be used as the one and only link through the entire process, from manufacturing to distribution and, subsequently, brand inspection and consumer crowdsourcing. However, in other embodiments, another universally or globally unique code or identifier may be used.

By using a GS1 Digital Link through the entire product's lifecycle, from manufacturing to distribution, the authentication techniques may provide complete traceability of a product using a single identifier. For example, if a product is scanned at an unexpected location, the computer system may be able to trace back through the product's lifecycle to see where things occurred.

### Manufacturing and Supply Chain

Products are often made of many elements. These are often added to the product in different locations and parts of assembly lines. These specific elements usually do not need to have their own unique code as long as there is a unique, globally identifiable code on the product as it goes out of the factory. This code may, theoretically, be able to trace all of the individual components of the product(s) and where/when they were added.

Furthermore, using a unique code (such as serialized GS1 Digital Link) on the product may provide transparency into the distribution channel, such that we know when it was scanned, where it went, where it arrived, etc. At one point, the product may be broken down and distributed to different stores. Using this GS1 Digital Link in the store, a consumer that scans the code with context (such as information about the associated product or environment, e.g., the location of a store, a type of store, etc.) may send this code and information to the computer system. This code and the information may be used by the computer system to authenticate the product and/or to provide feedback about the product to the supply chain.

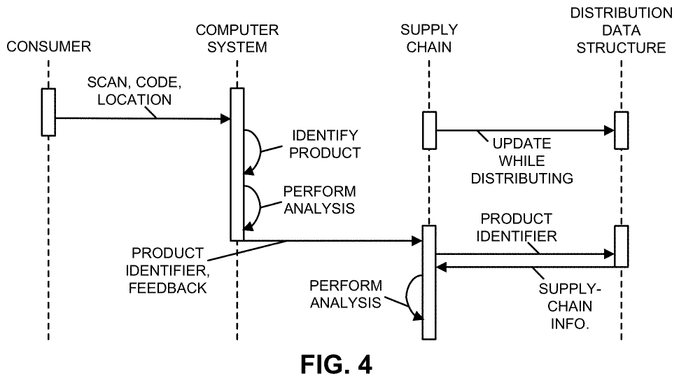

As shown in FIG. 4, which presents a drawing illustrating a manufacturing and supply-chain flow, a consumer may scan a product and the scan results and the location may be sent to a cloud-based computer system. The cloud-based computer system may: identify the product, run one or more analysis techniques and provide the product identifier and feedback to the supply chain. The supply chain may share the product identifier with a distribution data structure or database. This data structure or database may share the supply-chain information back through the supply chain, where it may be then analyzed. The different analysis techniques are described further below.

### Analysis Techniques for Accessing Product Authenticity

Because product identities in the present disclosure may use unique Internet addresses (e.g., URLs/URIs that use the GS1 Digital Link standard) per product, the addresses may be globally unique, centrally traced codes. When an identifier is scanned anywhere on the planet, the computer system may identify if it has been scanned elsewhere. Because the only way to legally give a product a valid link may be to give it a new and unique code, the codes cannot be duplicated. In fact, using the GS1 Digital Link may generate a second-factor authentication, such that a forger will have to provide both a new code (that is not used by anyone else) and a URI with information that duplicates the original. This extra effort is something most forgers do not perform when they duplicate a tag.

Moreover, the analysis techniques may be used to identify, trace and provide assessments of product links (e.g., GS1 Digital Links) and potential duplicates. By using Internet addresses as product identifiers that can be scanned by consumers and supply-chain systems (as well as used in the analysis techniques), products can be assessed for authenticity by the computer system and this authentication can be used to trace gray-market/black-market goods. A set of analysis techniques that address specific supply-chain integrity problems are described further below.

### Detection of Duplicate Product Identities (Counterfeit Identities)

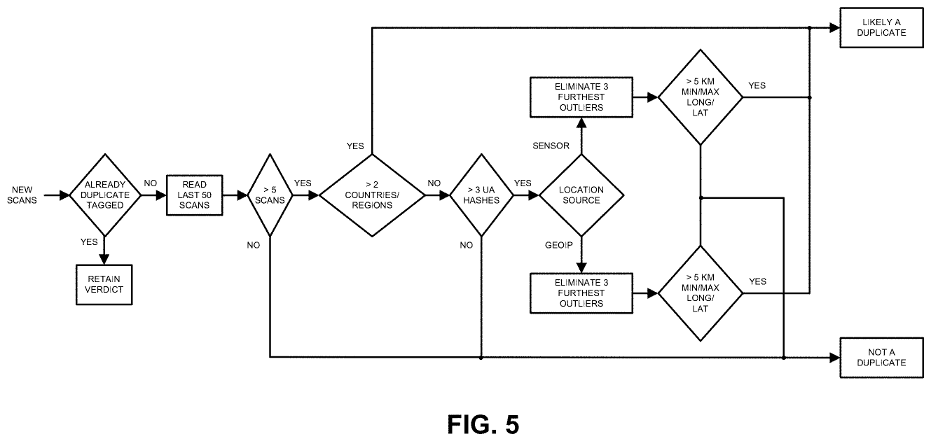

FIG. 5 is a drawing illustrating a duplicate-flow-detection analysis technique. Notably, FIG. 5 illustrates operations in the detection of duplicate product item identities. This analysis technique may include factors, such as: volume, a number of countries or regions, a number of user agents (UA) and/or a distance spread. Moreover, the analysis technique may use parameters such as: a scan threshold (e.g., 5), a region threshold (e.g., 2), a user-agents threshold (e.g., 3), a geographic-spread threshold (e.g., 20), a sensor-spread threshold (e.g., 5), a sensor-outlier threshold (e.g., 3), and/or a maximum-observed scans (e.g., 50).

For example, a given identity that has been copied on many products may identify a source of counterfeits products. One of the inputs to this analysis technique may be a consumer scan, such as at least a portion of an image acquired by a consumer using an electronic device. Notably, when the identity is scanned, the context may be captured, including: a location of the scan (e.g., using GPS coordinates, reverse geolP or determining the location based at least in part on an IP address, or another location technique).

In some embodiments, the scan may be performed by an application executed on the electronic device. For example, the application may be software or program instructions that executes in an environment of an operating system on the electronic device. In some embodiments, the application may be a browser user agent that executes in an environment of a Web browser.

Then, a determination may be made (e.g., by the application and/or the computer system) as to whether the identifier has been scanned by consumers more than or equal to a scan-threshold number of times (such as more than once). If not, the identifier is likely not a duplicated code. Moreover, a determination may be made e.g., by the application and/or the computer system) as to whether scans have occurred in more than a regions-threshold number of countries or regions (such as more than one). If so, the identifier is likely a duplicated code. Furthermore, a determination may be made (e.g., by the application and/or the computer system) as to whether scans have been performed by more than or equal to a number of user-agent-threshold electronic devices (such as more than one). These electronic devices may be identified by performing a secure (such as MD5) hash on the context user agent associated with each scan and counting the unique values. If not, the identifier is likely not a duplicated code. Instead, the identifier may be a single user scanning the same item. Additionally, a determination may be made (e.g., by the application and/or the computer system) as to whether scans are taking place over an unusually large geographic area. This may be assessed by the diagonal distance between the minimum and maximum latitude and longitude of the scans. For example, for all the locations of the scans (such as GPS coordinates), is the maximum distance between a pair of the scans greater than a location-spread threshold (e.g., in km) after removing location-spread-threshold outliers. If so, the identifier is likely a duplicated code. Alternatively, if not, the identifier is likely not a duplicated code, but could be the result of retail interest in the product. Similarly, for all the locations of the scans (such as geolP locations), is the maximum distance between a pair of the scans greater than a geolP-spread threshold (e.g., in km) after removing location-spread-threshold outliers. If so, the identifier is likely a duplicated code. Alternatively, if not, the identifier is likely not a duplicated code, but could be the result of retail interest in the product.

### Detection of Unexpected Location (Parallel Imports)

We now describe operations used to detect unexpected locations, which may be a source of parallel import, e.g., imports where the products end up in a different market than expected/allowed. One of the inputs to this analysis technique may be a consumer scan.

Notably, a scan may capture the target destination of a product (e.g., based at least in part on a portion of a purchase order). When the product identity is scanned by a consumer (e.g., based at least in part on at least a portion of an image acquired by an electronic device used by the consumer), the scan may capture context, including: a location (or ‘scan location’) of the scan (using GPS coordinates, reverse geolP or another location technique); an application used to perform the scan (such as a browser user agent); and/or a country for the scan location. Note that when the scan-location country is not equal to the target or destination country, then the product is likely to be a parallel import.

### Factory Activation and Detection of Un-Activated Product Identifiers (Backdoor Goods)

We now describe operations used to detect identifiers that have not been activated, which may be a source of backdoor goods, e.g., goods that are illegally produced by the same factories the brands use for producing their legal items.

Notably, X identifiers having unique Internet addresses may be produced or assigned (at least one for each product). During manufacturing, one or more identifiers may be affixed or attached to a product. Then, the identifiers may be scanned at the end of the manufacturing process/during quality assessment and activated (e.g., by registering the identifiers with the computer system).

Subsequently, the product identifier may be scanned by a consumer (e.g., to engage with a marketing campaign). The computer system may use information acquired in the scan to check if the identifier has been activated. If not, then the product is likely a backdoor good.

### Supply-Chain Feedback Loop

By using a GS1 Digital Link through the entire product's lifecycle (from manufacturing to distribution), the authentication techniques may provide complete traceability of a product and information can be continuously fed back into the supply chain, thereby creating a feedback loop. For example, if a product is scanned in an unexpected location, the computer system may trace back through the lifecycle of the product to see where things occurred. Note that the computer system may interface with the supply chain in the disclosed authentication techniques.

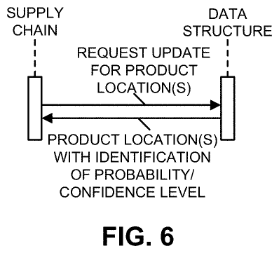

FIG. 6 presents a drawing illustrating a supply-chain feedback loop. Notably, a supply chain may use the feedback loop to request an update for one or more product location(s). Note that the data structure or database may share the product location(s), as well as an identifier probability/confidence level.

### Image-Based Crowdsourcing and Supply-Chain Management

As noted previously, many solutions that attempt to provide visibility into supply-chain integrity issues (such as gray markets, backdoor goods or counterfeit products) focus on tags that are hard to copy and/or brand inspectors purchasing and analyzing items in stores. Brand inspectors purchase products and inspect them to identify if they are authentic or not, e.g., based on predetermined quality standards, and provide this information to the supply chain. However, one challenge with brand inspectors is that, when analyzing a product through imaging, the photograph may need to be taken in such a way that it is extremely accurate and from a particular angle or perspective. In the disclosed authentication techniques, brand inspectors can be simulated by consumers taking one or more images or photographs of a product and through the use of crowdsourcing.

At a high level, the operations in the authentication techniques may include generating a 3D image of a product during the manufacturing process. Then, a consumer may take an image of the product (e.g., in a retail establishment). Over time, multiple consumer-acquired scans/images may provide an understanding of the product (e.g., this product is frequently seen at this location, from different angles or perspectives, etc.). These images may or may not include tags. For example, some stores may use their own tags, which may cover the supply-chain tags, or the tags may be fake. Thus, the authentication techniques may not rely on tags. Next, the computer system may use a correlating and matching data structure or database to compare the image(s) from the manufacturing process with the consumer scan(s). The results of this consumer crowdsourcing may be fed back into the supply chain. This may provide improved visibility as to where products are bought and sold, and/or the supply-chain identifiers in order to help better understand product distribution.

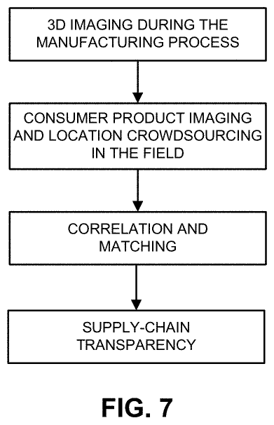

FIG. 7 presents a drawing illustrating an image-based crowdsourcing technique. Notably, this image-based crowdsourcing technique may begin with 3D imaging during the manufacturing process. Then, the consumer(s) may perform product imaging and location crowdsourcing in the field, which is subsequently stored in a correlation and matching data structure or database. As noted previously, the results of these authentication techniques may provide improved supply-chain transparency.

### 3D Imaging During the Manufacturing Process

During the manufacturing process, multiple images may be acquired in order to render a 3D image of the product. For example, a visual scan of a product may be performed from multiple angles or perspectives using a predefined or pretrained predictive model or a pretrained machine-learning model (such as a supervised learning model or a neural network). Then, a 3D view of the product may be generated, so that when an image is taken in the field by an untrained customer or by someone who passes by with an arbitrary viewing angle, lighting and/or color temperatures, the computer system may not be limited in its understanding or ability to analyze or evaluate the scan(s).

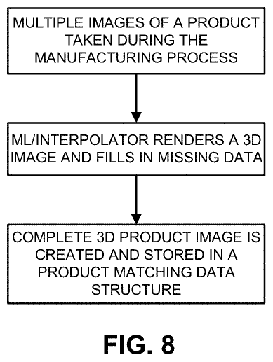

FIG. 8 presents a drawing illustrating a 3D imaging technique during manufacturing. Notably, FIG. 8 illustrates that a 3D image may be generated by taking multiple photographs or images on an electronic device so that the information for a 3D rendering of the product is acquired. However, an infinite number of photographs do not need to be acquired. Instead, only a few may be provided to a computer system, which may consolidate the images and automatically fill in the gaps or missing information in order to render the 3D image or model. This 3D image may be stored in a manufacturing data structure or database. As noted previously, in the disclosed embodiments, the consumer may not use a tag. Instead, the consumer may scan/take one or more images of a product.

Thus, the scanning and/or imaging of products may occur during the manufacturing process and may be stored in a product-matching data structure or database for subsequent use in product matching/correlation. Additionally, these images may be acquired during different stages in the manufacturing process (e.g., cutting the fabric, sewing sections, a finished product, etc.). In each operation in the manufacturing chain, several photographs may be taken of the product. This chain of images may create a view of the product and this 3D imaging of the product may correlate well with the consumers' images of the same product taken in the field (e.g., in a store, at home, etc.). Note that the images taken in the manufacturing process may be biased towards the type of images or perspectives that will be or that are expected to be subsequently acquired by the consumer (e.g., this may need to happen in order to ensure a product can be identified using the manufacture image and the consumer image). For example, there may be particular perspectives of a product that are more likely to occur based at least in part on the shape of the product.

When photographs of a product or object are taken during the manufacturing process, they may include multiple angles or perspectives of the product for the data structure or database. The multiple images may be processed to fit a 3D shape or model, such as a ball that represents an infinity of 3D viewing angles or perspectives. This 3D model may allow a consumer, who may subsequently acquire photograph(s) of the product at an arbitrary angle, to provide useful information.

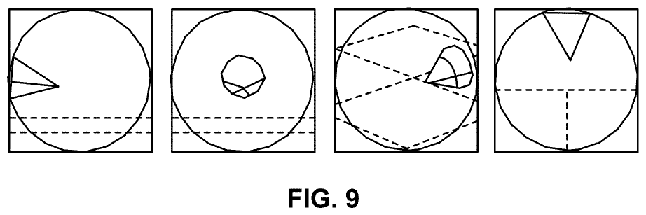

During the matching/correlation process described below, an image or scan may be compared to this 3D depiction or model of the product. Potential angles or perspectives of a product (such as, e.g., a cone-like-object) are depicted in FIG. 9, which presents a drawing illustrating potential perspectives of a product. Note there may be N photographs taken of any given object, where N is a non-zero integer.

In some embodiments, when images are taken during the manufacturing process, the computer system may identify blemishes associated with a specific line of products. If there is a tag or multiple tags, they may be included in the 3D image and may be analyzed separately or in conjunction with other acquired information.

### 3D-Image Data Structure or Database Training

In disclosed embodiments, actual images may not be stored in a data structure or database. Instead, a predefined or pretrained predictive model (such as a neural network, e.g., a CNN) may perform image classification. The classification may be relative to an expert brand-inspector scanning. When a brand inspector is examining a product, that may look at it or view it from a range of angles. Part of this range may deliver inconclusive, but relevant information. Other angles may be more conclusive or decisive. The accumulation of information may make the authentication decision accurate. The computer system may build a data structure or database with this type of information. As shown in Table 1, the results may be one of four options.

TABLE 1

| Result | Color |
|---|---|
| Inconclusive: Not Relevant | Red |
| Inconclusive: Relevant | Blue |
| Close But Not Conclusive | Yellow |
| Conclusive: Highly Likely. | Green |

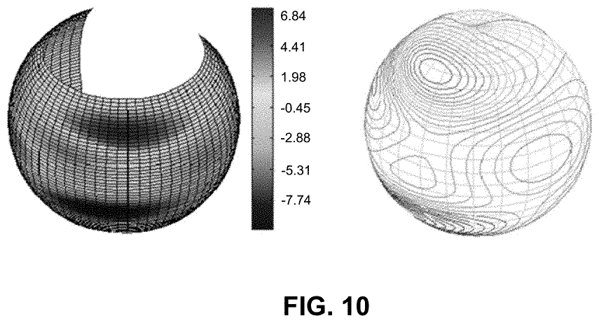

FIG. 10 presents a drawing illustrating a 3D ball with surface sectors, which is an example of the information in the 3D data structure. This 3D ball may be divided into surface sectors that fall under the four map options in Table 1. The map of the 3D ball may be a heat map in which color variations indicate how close or how far a region is from a particular color.

Depending on the angle in which the ball is viewed, there are different patches with different colors in FIG. 10. As previously described, a similar process may be performed for an imaged or scanned product. Thus, the product may be color mapped without the use of other analysis technique(s). In some embodiments, a human expert may review the image to identify what is relevant and what is irrelevant. Alternatively, a predictive model may be trained to do this (such as a machine-learning model, e.g., a neural network), and the images from each sector or option may be used to train the predictive model. Once the predictive model is trained, the computer system may respond with a result, such as conclusive or inconclusive. The pretrained predictive model may be engaged if a product is deemed to be some percentage relevant. For example, a clearly irrelevant or inconclusive product image may not be evaluated by the pretrained predictive model.

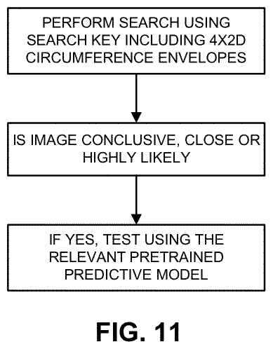

Note that the data structure or database may be a collection of predictive models. Moreover, when performing a search of the data structure or database, a key for a given product may include four 2D circumference envelopes of the product. Furthermore, an image that is an approximate match to any of the envelopes may be evaluated by the relevant pretrained predictive model for the product. In some embodiments, the envelope can be associated with multiple products. FIG. 11 presents a drawing illustrating a comparison technique.

In some embodiments, the data structure or database may be sorted using a hash key that is a mathematical representation of a circumference of an image. Note that the circumference may refer to the circumference of an image as opposed to the circumference of a product in the data structure or database. As noted previously, the data structure or database may include GS1 Digital Links.

### Consumer Product Imaging and Crowdsourcing

Consumers may take a picture of a product from different angles or perspectives in a store where it is being purchased, or where they are looking at the product, and may upload this image to an application. The authentication or identification of a product may be achieved by comparing the manufacturing image to the consumer image of the product. Once again, the authentication may not be based on a product tag. Instead, the actual product may be used.

It may be likely that a consumer providing a crowdsourced image may not take an image of the backside of a product on display. However, it is possible that different consumers may take images of the same product from a different angle or perspective (e.g., the front, the side, the back, etc.). Thus, while it is not likely that a consumer providing a crowdsourced image may take an image of the backside of a product on display, this information may be acquired via the gamification process described below.

### Consumer Crowdsourcing

Consumer crowdsourcing may include multiple consumers taking pictures of the same product in the same location/store. By doing this, the computer system may get multiple images of the same product, but from multiple angles or perspectives. Note that multiple angles may occur because different consumers have different heights, and images of the same product may be acquired at different locations, angles or times of day. For example, one consumer may take a picture of a shirt in the morning at a lower incident angle, while a second consumer may take a picture of the same shirt in the afternoon from a slightly different angle or perspective.

This is a form of crowdsourcing in which multiple images from different consumers create more-accurate authentication or identification of a product. Just as with the manufacturing-process imaging, a 3D image of the product can be rendered using scans from different consumers at multiple angles or perspectives of this product. Note that a 3D image of a product may be created during the manufacturing process and/or the crowdsourced consumer-product imaging.

Additionally, the use of crowdsourced consumer images may improve the likely authenticity of a product and may be used to provide a more-accurate replacement for a human-field inspector or brand inspector, who would otherwise physically scan products and send them for analysis. In these authentication techniques, note there may M number of consumers scanning a single product, where M is a non-zero integer. Moreover, the consumer photographs may be compared to/correlated with a product matching data structure or database as described below.

sRecord Data Structure Database (Based At Least in Part On Consumer Reports)

A record data structure or database may be created and may include information, such as an image, a date, a time, and/or confidence level. The record may be broken down into two sections: a location, and a product. The data structure or database is illustrated in Table 2.

TABLE 2

| Record | Description |
|---|---|
| Location | Prefix |
| Image 1, date, time | |
| Image 2, date, time | |
| . . . | |
| Image i, date, time | |
| Product 1 confidence level | Product 1 |
| Image x | |
| Image y | |
| . . . | |
| Image j | |
| Product 2 confidence level | Product 2 |
| Image x | |
| Image y | |
| . . . | |
| Image k | |
| . . . | . . . |
| Product n confidence level | Product n |
| Image x | |
| Image y | |
| . . . | |
| Image m | |

An image for inclusion in the record may include: a location, a date and a time, which may be recorded in the prefix of the record. The prefix of the record may be arranged, such that images (plus date and time) are included with or associated with their given location. The second part of the record may operate on a per-product basis. For each product, images may be linked to a product and a confidence level. Moreover, each new image that is sent to the record may be analyzed and a corresponding confidence level may be established. Note that an image may include or may correspond to one or many products. Therefore, the prefix may be analyzed.

Note that locations may be grouped, e.g., in a large store or retail establishment. This may apply to embodiments where products are distributed throughout a large department store.

### Correlation and Matching Data Structure or Database

A correlation and matching data structure or database for products/objects may be created during the manufacturing process and may be used when a consumer takes a photograph of a product/object and the computer system identifies and authenticates the product/object.

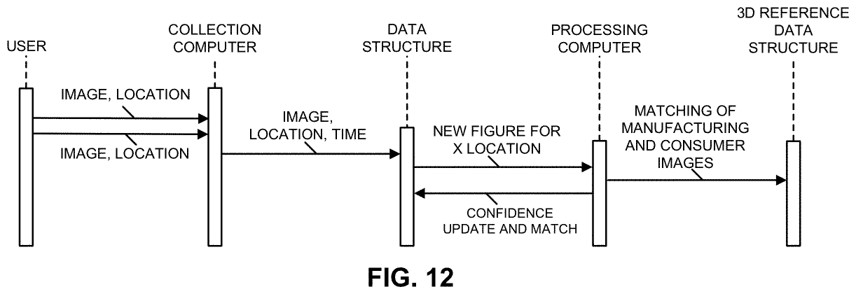

FIG. 12 presents a drawing illustrating a correlation and matching flow.

The data structure or database associated with this flow may include 3D rendered images of a product. When a user/consumer takes an image or a photograph, a location of this photograph may also be stored and shared with the computer system. By doing so, the computer system may be able to track products and their location for authentication purposes and for increased supply-chain transparency. The computer system may share the image, location, and time with the data structure or database. Moreover, the computer system may physically match and correlate the consumer image in relation to the manufacturing image from the 3D reference data structure or database. The computer system may send back a match probability or confidence level to the data structure or database.

This process may create a new type of brand inspector, a crowdsourced-consumer brand inspector. In these embodiments, the brand inspector may now be the consumer, or the crowdsourcing of multiple consumers, and the correlation between the manufacturing image(s) and consumer image(s).

Note that the record information may include: the location, product identifier, the correlation probability (%), and/or a list of images taken at that specific location. When there is a new product for a specific location, it may be sent for analysis by the computer system. Moreover, the record of the images for a specific location may be sent for analysis by the computer system.

### Correlation and Supply-Chain Transparency

The scanning of products in different places may provide the location, time of imaging, and other information about the product. This information may be supplied to the supply chain (such as to one or more computers) to demonstrate where products are being bought and sold. In addition, there can be supply-chain identifiers in a product that specifically identify how a product is being distributed.

### Gamification of the Authentication by the Crowd

When gamification is used for the crowd-sourced information, individuals may be asked to share the augmented-reality/virtual-reality input with the computer system as they play a game. These consumers or users may collect points when they ‘see’ (provide information about) a product. For example, a user may pick a product and scan it using a video feed or multiple images from multiple angles or perspectives. Moreover, the user may earn points for finding rare items/store combinations of particular products of a certain type/brand in different stores. Thus, during a game, a user may be a brand inspector and may try to spot products that they think should not be at a location or are counterfeit and may be asked to describe why.

The disclosed embodiments may be gamified by brands to entice consumers to acquire different images of products in different places. In the embodiments of gamification, users/consumers may be enticed by rewards. For example, the location and identity of a user may be requested, and they may be asked to take multiple images of a product. If the brand/computer system can identify and/or authentication a product based at least in part on the imaging and information from a user, a game avatar of the user may receive an upgrade or they unlock new elements in their augmented-reality game.

This approach may be compared to a game that uses GPS and a clock on an electronic device of a user to detect where they are and when they are in the game, and to make an avatar ‘appear’ around them to catch them. This premise may encourage users to experience a game in the real world, but also may provide users with rewards and encouragement. This process may be implemented for the gamification of product scanning.

### Blockchain Wallets for Privacy

A challenge in online crowdsourced-based information systems is to keep information associated with the players (the individuals) protected while receiving relevant detailed environmental information while the users play a game (including their location and/or other environmental information, such as sounds, images or video streams). In order to protect the privacy of the users, the authentication techniques may remove the need for any personal information in the information provided to the cloud-based computer system.

Notably, in some embodiments, a given player of a game may instantiate a blockchain wallet. Moreover, when installing the application on their edge electronic device, the user may provide the electronic device with their wallet public key. Furthermore, when data is collected, the public key may be provided along with analyzed data to the computer system. Additionally, when the computer system deems the collected data relevant, blockchain may be used to pay the user with association to the data stream collected as part of the game. For example, the computer system may credit the wallet identity using the public key. This approach may remove the need to have any personal information included in the data stream and may provide an anonymized technique to credit the correct user for their efforts.

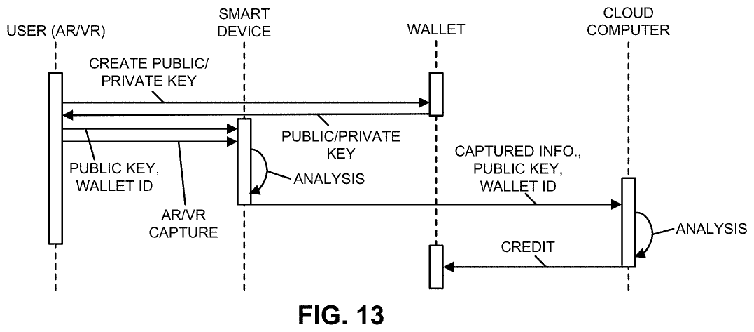

FIG. 13 presents a drawing illustrating a privacy-based crowdsourcing flow. Notably, FIG. 13 depicts a system where the user information is shared while maintaining privacy and allowing for payment back to the user without knowing the actual user identity. Note that this approach may be allowed, because there is no financial transaction from the user to the cloud-based computer system, but the other way around.

### AR/VR-Based Edge Analysis and Mapping

Augmented reality/virtual reality edge electronic devices (such as smart glasses or smartphones) may access various services and/or applications that provide real-time vision information, as well as adding overlay information on existing and/or other virtual realities at the exact vectorized location or position of the user. For example, a service may allow users, when looking at a product, to get more information about that product, such as: material, size, price, origin, reviews, etc.

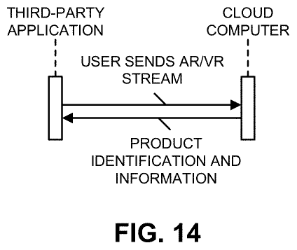

FIG. 14 presents a drawing illustrating a product-identification flow. Notably, FIG. 14 shows the general process for user to cloud-based-computer system streaming and product identifier/information retrieval. This scanning of a product may generally include an associated context (such as a time, a location, a date, what products are that location that are or are not listed, etc.). In order to enable this information, local vendors may have to publish information that a cloud-based computer system can access and use to better serve the customers.

The augmented reality/virtual reality user electronic device may be a smart electronic device or may be connected to a smart electronic device (such as a smartphone) to establish cloud or network connectivity. The processing power and complexity that is used to augment the reality for the user with contextual information about a product may not reside on the edge user electronic device, but may be performed by the cloud-based computer system. Note that, in the disclosed embodiments, an edge-based application may analyze the augmented reality/virtual reality stream to extract GS1 codes or other product relevant codes.

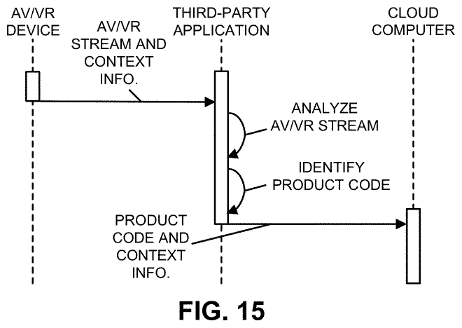

FIG. 15 presents a drawing illustrating edge-based analysis and mapping. Notably, FIG. 15 shows the general flow for augmented reality/virtual reality-based edge analysis and mapping. For example, an augmented reality/virtual reality electronic device of a user may send a video stream and context information to a third-party application, where it is analyzed and the product code may be extracted or identified. The product code and the context information may then be sent to the cloud-based computer system. This code and the context information may be used as part of the authentication process and supply-chain management.

In general, in the authentication techniques there may be specific things that need to be identified, e.g., identifiers or codes. For example, as a consumer/user walks around an environment, they can read GS1 codes. The application on their electronic device may read or analyze a stream of images and may identify codes. It may also be aware of the location of the user and other context-specific data. The location of the user may ensure that, when the user walks by the same product with a GS1 code in the same location, this product may be accounted for once (as opposed to all the times it was scanned or images of it were acquired). Thus, the disclosed embodiments can address duplicated scans of the same GS1 codes (e.g., GS1 Digital Links).

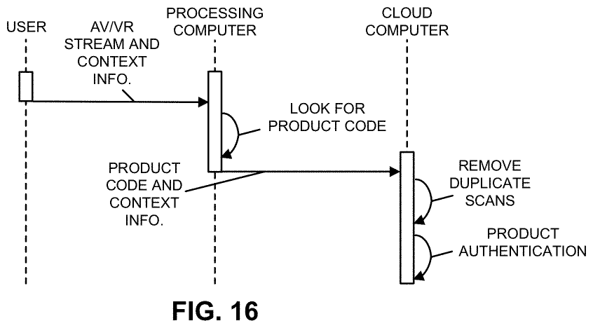

FIG. 16 presents a drawing illustrating removal of duplicate scans and product authentication. Notably, FIG. 16 shows the general process of identifying and removing duplicate scans and authenticating a product. For example, an augmented reality/virtual reality electronic may send the stream and context information to a processing computer system or application, where a search is made for a product code. When the product code is found, the code and the context information may be sent to the cloud-based computer system. The cloud-based computer system may use this information to remove duplicate scans and to authenticate a product.

In other embodiments, the computer system may use image identification. Notably, in order to avoid cloud-based processing, during the gamified process, a user may use a cloud-based service to enable object identification by a third party. Note that this user may have a cloud-based account according to the disclosed embodiments.

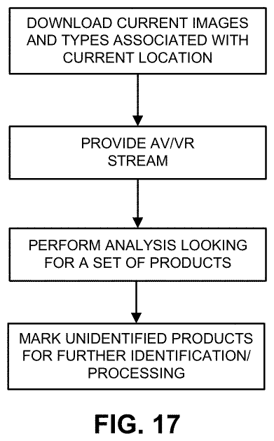

FIG. 17 presents a drawing illustrating a product identification technique. During this product identification technique, a computer system may, based at least in part on the user location, download to the edge electronic device possible products images and types to track at a particular location.

As the user streams augmented reality/virtual reality data, a local application may perform analysis looking for the limited set of products by piggybacking on the in-view information received from a third-party cloud application. These embodiments may remove the need to provide a full image analysis in the cloud. Instead, the third-party service may handle the identification of the product (such as extracting the identifier or the code), and the application executing on the smart electronic device may handle the authentication of this product if it is included in the set of products.

Note that every product marked by the third-party application and that is not in the local set of products may be selected or chosen by the user to mark for the third-party service to explore. In some embodiments, the user may do so as part of the crowdsourced game they are playing.

We now describe embodiments of an electronic device, which may perform at least some of the operations in the authentication techniques. FIG. 18 presents a block diagram illustrating an example of an electronic device 1800 in accordance with some embodiments, such as electronic device 110, electronic device 112, access point 114, base station 116, one of computers 120, etc. This electronic device includes processing subsystem 1810, memory subsystem 1812, and networking subsystem 1814. Processing subsystem 1810 includes one or more devices configured to perform computational operations. For example, processing subsystem 1810 can include one or more microprocessors, ASICs, microcontrollers, programmable-logic devices, one or more graphics process units (GPUs) and/or one or more digital signal processors (DSPs).

Memory subsystem 1812 includes one or more devices for storing data and/or instructions for processing subsystem 1810 and networking subsystem 1814. For example, memory subsystem 1812 can include dynamic random access memory (DRAM), static random access memory (SRAM), and/or other types of memory. In some embodiments, instructions for processing subsystem 1810 in memory subsystem 1812 include: one or more program modules or sets of instructions (such as program instructions 1822 or operating system 1824), which may be executed by processing subsystem 1810. Note that the one or more computer programs may constitute a computer-program mechanism. Moreover, instructions in the various modules in memory subsystem 1812 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1810.

In addition, memory subsystem 1812 can include mechanisms for controlling access to the memory. In some embodiments, memory subsystem 1812 includes a memory hierarchy that comprises one or more caches coupled to a memory in electronic device 1800. In some of these embodiments, one or more of the caches is located in processing subsystem 1810.

In some embodiments, memory subsystem 1812 is coupled to one or more high-capacity mass-storage devices (not shown). For example, memory subsystem 1812 can be coupled to a magnetic or optical drive, a solid-state drive, or another type of mass-storage device. In these embodiments, memory subsystem 1812 can be used by electronic device 1800 as fast-access storage for often-used data, while the mass-storage device is used to store less frequently used data.

Networking subsystem 1814 includes one or more devices configured to couple to and communicate on a wired and/or wireless network (i.e., to perform network operations), including: control logic 1816, an interface circuit 1818 and one or more antennas 1820 (or antenna elements) and/or input/output (I/O) port 1830. (While FIG. 18 includes one or more antennas 1820, in some embodiments electronic device 1800 includes one or more nodes, such as nodes 1808, e.g., a network node that can be coupled or connected to a network or link, or an antenna node or a pad that can be coupled to the one or more antennas 1820. Thus, electronic device 1800 may or may not include the one or more antennas 1820.) For example, networking subsystem 1814 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, a cable modem networking system, and/or another networking system.

Networking subsystem 1814 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1800 may use the mechanisms in networking subsystem 1814 for performing simple wireless communication between the electronic devices, e.g., transmitting advertising or beacon frames and/or scanning for advertising frames transmitted by other electronic devices as described previously.

Within electronic device 1800, processing subsystem 1810, memory subsystem 1812, and networking subsystem 1814 are coupled together using bus 1828. Bus 1828 may include an electrical, optical, and/or electro-optical connection that the subsystems can use to communicate commands and data among one another. Although only one bus 1828 is shown for clarity, different embodiments can include a different number or configuration of electrical, optical, and/or electro-optical connections among the subsystems.

In some embodiments, electronic device 1800 includes a display subsystem 1826 for displaying information on a display, which may include a display driver and the display, such as a liquid-crystal display, a multi-touch touchscreen, etc.

Electronic device 1800 can be (or can be included in) any electronic device with at least one network interface. For example, electronic device 1800 can be (or can be included in): a computer system (such as a cloud-based computer system or a distributed computer system), a desktop computer, a laptop computer, a subnotebook/netbook, a server, a tablet computer, a smartphone, a cellular telephone, a smartwatch, a consumer-electronic device, a portable computing device, an access point, a transceiver, a router, a switch, communication equipment, a computer network device, a stack of computer network devices, a controller, test equipment, a printer, and/or another electronic device.

Although specific components are used to describe electronic device 1800, in alternative embodiments, different components and/or subsystems may be present in electronic device 1800. For example, electronic device 1800 may include one or more additional processing subsystems, memory subsystems, networking subsystems, and/or display subsystems. Additionally, one or more of the subsystems may not be present in electronic device 1800. Moreover, in some embodiments, electronic device 1800 may include one or more additional subsystems that are not shown in FIG. 18, such as a user-interface subsystem 1832. Also, although separate subsystems are shown in FIG. 18, in some embodiments some or all of a given subsystem or component can be integrated into one or more of the other subsystems or component(s) in electronic device 1800. For example, in some embodiments program instructions 1822 are included in operating system 1824 and/or control logic 1816 is included in interface circuit 1818.

Moreover, the circuits and components in electronic device 1800 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 1814 (or, more generally, of electronic device 1800). The integrated circuit may include hardware and/or software mechanisms that are used for transmitting wireless signals from electronic device 1800 and receiving signals at electronic device 1800 from other electronic devices. Aside from the mechanisms herein described, radios are generally known in the art and hence are not described in detail. In general, networking subsystem 1814 and/or the integrated circuit can include any number of radios. Note that the radios in multiple-radio embodiments function in a similar way to the described single-radio embodiments.

In some embodiments, networking subsystem 1814 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Ethernet, a cellular-telephone communication protocol and a Wi-Fi communication protocol as an illustrative example, in other embodiments a wide variety of communication protocols and, more generally, wired and/or wireless communication techniques may be used. Thus, the authentication techniques may be used with a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the authentication techniques may be implemented using program instructions 1822, operating system 1824 (such as a driver for interface circuit 1818) or in firmware in interface circuit 1818. Alternatively or additionally, at least some of the operations in the authentication techniques may be implemented in a physical layer, such as hardware in interface circuit 1818.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the authentication technique, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
a network interface configured to communicate with an electronic device and a second computer;
a processor; and
memory configured to store program instructions, wherein, when executed by the processor, the program instructions cause the computer system to perform operations comprising:
receiving, associated with the electronic device, information associated with a portion of an image of a product, wherein the information specifies an identifier of the product and a location where the image was acquired;
determining whether the identifier is authentic; and
when the identifier is authentic, providing, addressed to the second computer, feedback information about the product, wherein the second computer is associated with or is included in a supply chain of the product.

2. The computer system of claim 1, wherein the identifier comprises a universal unique identifier.

3. The computer system of claim 2, wherein universal unique identifier comprises an identifier compatible with a GS1 Digital Link standard.

4. The computer system of claim 1, wherein the identifier specifies a second location in a network.

5. The computer system of claim 4, wherein the second location comprises a uniform resource locator (URL), a uniform resource identifier (URI) or both.

6. The computer system of claim 1, wherein the feedback information comprises the location and a timestamp when the image was acquired.

7. The computer system of claim 1, wherein the feedback information comprises a context about use of the product.

8. The computer system of claim 1, wherein the authenticity is determined based at least in part on a geographic constraint on the product and the location.

9. The computer system of claim 1, wherein the authenticity is determined based at least in part on second information specifying the identifier and a second location where a second portion of a second image of the product was acquired; and
wherein the second location is different from the location and a timestamp when the image was acquired is within a time interval of a second timestamp when the second image was acquired.

10. The computer system of claim 1, wherein the electronic device is associated with a third party and the information is received as part of a crowdsourced game.

11. The computer system of claim 1, wherein the portion of the image is extracted by an application installed on and executed by the electronic device.

12. The computer system of claim 1, wherein the image comprises a photograph of the product.

13. The computer system of claim 1, wherein the image comprises a scan of the identifier.

14. A non-transitory computer-readable storage medium for use in conjunction with a computer system, the computer-readable storage medium storing program instructions that, when executed by the computer system, cause the computer system to perform operations comprising:
receiving, associated with an electronic device, information associated with a portion of an image of a product, wherein the information specifies an identifier of the product and a location where the image was acquired;
determining whether the identifier is authentic; and
when the identifier is authentic, providing, addressed to a second computer, feedback information about the product, where the second computer is associated with or is included in a supply chain of the product.

15. The non-transitory computer-readable storage medium of claim 14, wherein the identifier comprises a universal unique identifier or specifies a second location in the network.

16. The non-transitory computer-readable storage medium of claim 14, wherein the authenticity is determined based at least in part on second information specifying the identifier and a second location where a second portion of a second image of the product was acquired; and
wherein the second location is different from the location and a timestamp when the image was acquired is within a time interval of a second timestamp when the second image was acquired.

17. A method for providing feedback information, comprising:
by a computer system:
receiving, associated with an electronic device, information associated with a portion of an image of a product, wherein the information specifies an identifier of the product and a location where the image was acquired;
determining whether the identifier is authentic; and
when the identifier is authentic, providing, addressed to a second computer, the feedback information about the product, where the second computer is associated with or is included in a supply chain of the product.

18. The method of claim 17, wherein the identifier comprises a universal unique identifier or specifies a second location in the network.

19. The method of claim 17, wherein the authenticity is determined based at least in part on a geographic constraint on the product and the location.

20. The method of claim 17, wherein the authenticity is determined based at least in part on second information specifying the identifier and a second location where a second portion of a second image of the product was acquired; and
wherein the second location is different from the location and a timestamp when the image was acquired is within a time interval of a second timestamp when the second image was acquired.
